(19) United States
(12) Patent Application Publication
(10) Pub. No.: US 2024/0177030 A1
(43) Pub. Date: May 30, 2024

(54) IDENTIFYING UNKOWN DECISION MAKING FACTORS FROM COMMUNICATIONS DATA

(71) Applicant: INTERNATIONAL BUSINESS MACHINES CORPORATION, Armonk, NY (US)

(72) Inventors: Matthias Graefe, Eppstein (DE); Daniel Thomas, Raleigh, NC (US); Zachary A. Silverstein, Georgetown, TX (US); Jacob Ryan Jepperson, St. Paul, MN (US)

(21) Appl. No.: 18/071,965

(22) Filed: Nov. 30, 2022

(51) Int. Cl. G06N 5/045; G06N 5/022

(52) U.S. Cl. CPC G06N 5/045; G06N 5/022; G06F 40/20

(57) ABSTRACT

Process mining systems and methods are provided for automatically identifying unknown decision making factors. In implementations, a computer-based method includes accessing a process model comprising a representation of steps in a lifecycle of a process, including a process step associated with a decision making point of the process, wherein a decision input at the decision making point determines a next step in the process from multiple next-step options; obtaining electronic communication data for communications between human participants in the process; analyzing the electronic communication data to identify decision making content associated with the decision making point; inputting the decision making content to a trained machine learning (ML) model, thereby generating an output of a decision making factor predicted to impact the decision input at the decision making point; automatically updating the process model based on the predicted decision making factor, thereby generating an updated process model.

### BACKGROUND

Aspects of the present invention relate generally to process mining and, more particularly, to automatically identifying unknown decision making factors from electronic communications data.

Various computer-implemented tools exist to facilitate business workflow processes, including decision making processes. Such tools include managing tools enabling the creation, testing and deployment of business processes, as well as automation tools that enable users to automate and govern rules-based digital workflows (e.g., business decisions). These tools include robotic process automation (RPA) tools, which comprise software technology that enables users to build, deploy and manage software robots that emulate human actions interacting with digital systems and software.

Business Process Model and Notation (BPMN) is a standardized graphical method or visual modeling language representing business processes or workflows within a business process diagram. A gateway in a BPMN notation is used to control how a process flows. Connected by sequence flows, a gateway acts as a decision point that decides which outgoing sequence flow to take based on an evaluation of predefined conditions. A condition may be, for example, yes or no, true or false, etc.

### SUMMARY

In a first aspect of the invention, there is a computer-implemented method including: accessing, by a processor set, a process model comprising a representation of steps in a lifecycle of a process, including a process step associated with a decision making point of the process, wherein a decision input at the decision making point determines a next step in the process from multiple next-step options; obtaining, by the processor set and from one or more digital collaboration platforms, electronic communication data for communications between human participants in the process; analyzing, by the processor set, the electronic communication data to identify decision making content associated with the decision making point of the process; inputting, by the processor set, the decision making content to a trained machine learning (ML) model, thereby generating an output of a decision making factor predicted to impact the decision input at the decision making point; automatically updating, by the processor set, the process model based on the predicted decision making factor, thereby generating an updated process model.

In another aspect of the invention, there is a computer program product including one or more computer readable storage media having program instructions collectively stored on the one or more computer readable storage media. The program instructions are executable to: access a process model comprising a representation of steps in a lifecycle of a process, including a process step associated with a decision making point of the process, wherein a decision input at the decision making point determines a next step in the process from multiple next-step options; obtain, from one or more digital collaboration platforms, electronic communication data for communications between human participants in the process based on timestamps of the communications; analyze the electronic communication data to identify decision making content associated with the decision making point of the process; input the decision making content to a trained machine learning (ML) model, thereby generating an output of a decision making factor predicted to impact the decision input at the decision making point; automatically update the process model to explicitly include the predicted decision making factor as part of the process, thereby generating an updated process model.

In another aspect of the invention, there is system including a processor set, one or more computer readable storage media, and program instructions collectively stored on the one or more computer readable storage media. The program instructions are executable to: access a process model comprising a representation of steps in a lifecycle of a process, including a process step associated with a decision making point of the process, wherein a decision input at the decision making point determines a next step in the process from multiple next-step options; obtain, from one or more digital collaboration platforms, electronic communication data for communications between human participants in the process; analyze the electronic communication data to identify decision making content associated with the decision making point of the process using natural language processing (NLP); input the decision making content to a trained machine learning (ML) model, thereby generating an output of a decision making factor predicted to impact the decision input at the decision making point; and generate and send a report to a user regarding the predicted decision making factor.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 depicts an overview of a decision discover process in accordance with embodiments of the invention.

FIG. 4 shows a flowchart of an exemplary method in accordance with aspects of the invention.

### DETAILED DESCRIPTION

Aspects of the present invention relate generally to process mining and, more particularly, to automatically identifying unknown decision making factors from electronic communication data. In embodiments of the invention, a computing device automatically identifies users associated with a task or step in an existing process workflow, automatically obtains and analyzes electronic communication data of the users, utilizes a trained machine learning (ML) model to identify qualitative and/or quantitative decision inputs or factors related to the task or step, and updates the process workflow with new rules (e.g., gateway rules) based on the identified qualitative and/or quantitative decision inputs or factors.

Business Process Tools, such as IBM® Business Process Manager (BPM), IBM® Business Automation Workflow (BAW), and IBM® Operational Decision Mangar (ODM), may be used to facilitate workflows (e.g., business processes). IBM® is a registered trademark of International Business Machines Corporation. In general, IBM® BPM and IBM® BAW allow users to interact and take actions in a process, such as filling out forms and approving items, wherein steps of the process may require unstructured user decision making (the decision making is not part of a formal/automated or documented decision making process). These unstructured user decisions often times need to be self-discovered by means of manual business analysis or partial discovery via Process Mining such as IBM® Process Mining.

In general, process mining refers to a family of techniques relating the fields of data science and process management to support the analysis of operational processes based on digital event logs, wherein the goal is to turn event data from event logs into data insights and actions. In general, event logs contain information regarding various steps that have been performed in a process, such as a unique identifier for a particular process instance, an activity (e.g., describing the event that occurred), and a timestamp indicating a time the activity occurred. While data from event logs is useful in analyzing operational processes, data not captured by the event logs (e.g., backchannel data) relating to a particular process instance may provide additional information that is not captured or identified during typical computer-based process mining.

Implementations of the invention address the technical problem of identifying decision-making factors that are not identified in digital event logs of an automated or semi-automated workflow processes. Advantageously, implementations of the invention provide an improved computer-based process mining system for identifying unknown user decision making steps or factors in a process (e.g., steps or factors not recorded in event logs) based on digital user communication data (inter-user communications). Embodiments of the invention provide additional (new) functionality to automated process mining tools to enable automated discovery of subjective and objective criteria utilized in a task step requiring decision making. In aspects of the invention, natural language processing (NPL) is utilized to process digital inter-user communications to extract associations with predetermined workflow steps, and associate decision making factors and subjective indicators of importance with a given step of the predetermined workflow.

In implementations, a decision discovery method includes: opting into an invention module, by a user device, to install a server-side module embedded within a process mining tool of the user device, and a server-side module embedded within a collaboration platform(s) of the user device (e.g., email or messaging applications). In embodiments, the decision discovery method further includes: extracting, by a business process tool or a process mining tool, relevant decision points through event log file processing or from Business Process Model and Notation (BPMN) notations of interactable workflows; and capturing and contextualizing, by the invention module, information (e.g., task title, task subject, fields captured, button titles, and notes associated with a given task or process) about the relevant decision points.

In embodiments, the decision discovery method further includes retrieving, by the invention module, timestamps of the relevant decision points (decision steps) and associated relevant information utilizing automated process mining. The relevant information may include: when a task is first picked up; the possible users who could pick up the task; the managers of each cluster of users; relevant business data marked as important or unique identifiers (e.g., customer name, ID, and other high value personalization components); and a timestamp(s) of a decision ending/endpoint.

In aspects, the decision discovery method also includes retrieving, by the user device, communications between users via collaborative platforms, such as instant messaging, email or audio platforms (e.g., video conferencing tools and digital telephone tools). The users of this step may include users who could pick up a task, possible downstream users who will retrieve the task, and managers of each cluster of users. In implementations, the decision discovery method also includes performing fuzzy logic matching, by the invention module, on text and audio information (e.g., spoken text) from the communications between the users in a predetermined timeframe associated with a decision point at issue (e.g., a predetermined time period before, during, and after the time of the decision point at issue). In embodiments, the audio information (spoken text) is captured by the user device and run through a text matching algorithm to identify an overlap where customer or case/process unique identifiers are found, and to further identify sentiment related decision content. Sentiment related decision content may include, for example, decision content such as “I like.” “I dislike.” “they need.” “I'm approving.” “I'm denying because . . . .” etc.

In aspects, when the decision content is found in a given communication between relevant users, the invention module utilizes natural language processing (NLP) to search the communication for unknown X-factors (decision making factors) by means of a co-sine similarity clustering method. Based on a history of multiple user's associations and discussion points, the user device extracts information decisions. In implementations, the decision discovery method further includes continuously iteratively retraining, by the invention module, a machine learning (ML) model based on the discussion points, wherein the ML model is configured to determine: subjective decision making requirements, objective decision making requirements, and user-specific decision making requirements for a given decision point. In implementations, the user device captures and appends the subjective decision making requirements, objective decision making requirements, and user-specific decision making requirements as rules for a process mining or BPMN decision point, thereby adding value to the BPMN decision and associated process optimization recommendations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as decision-making factor discovery 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

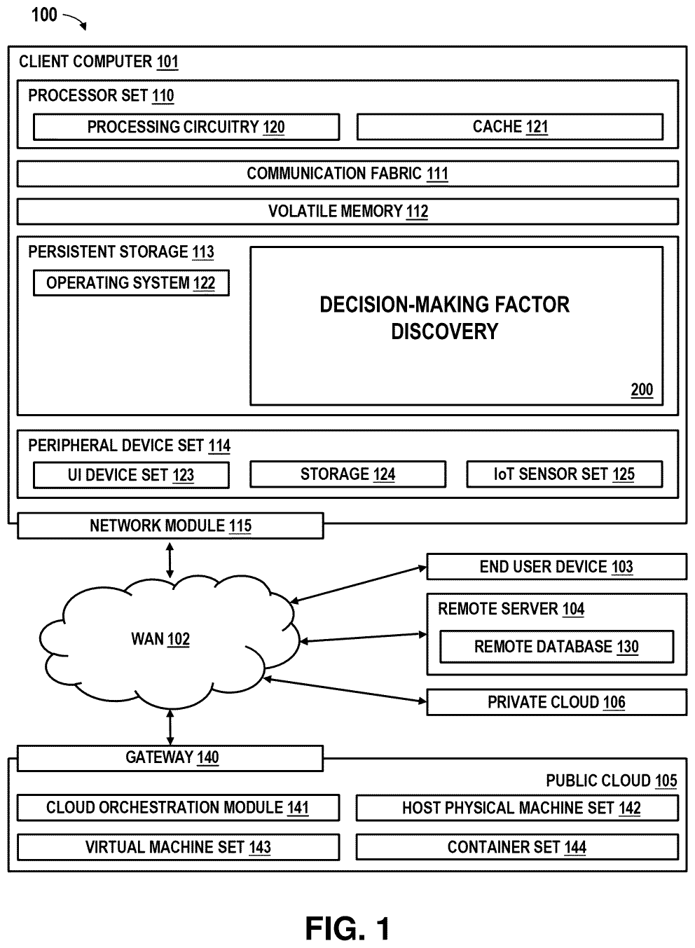

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

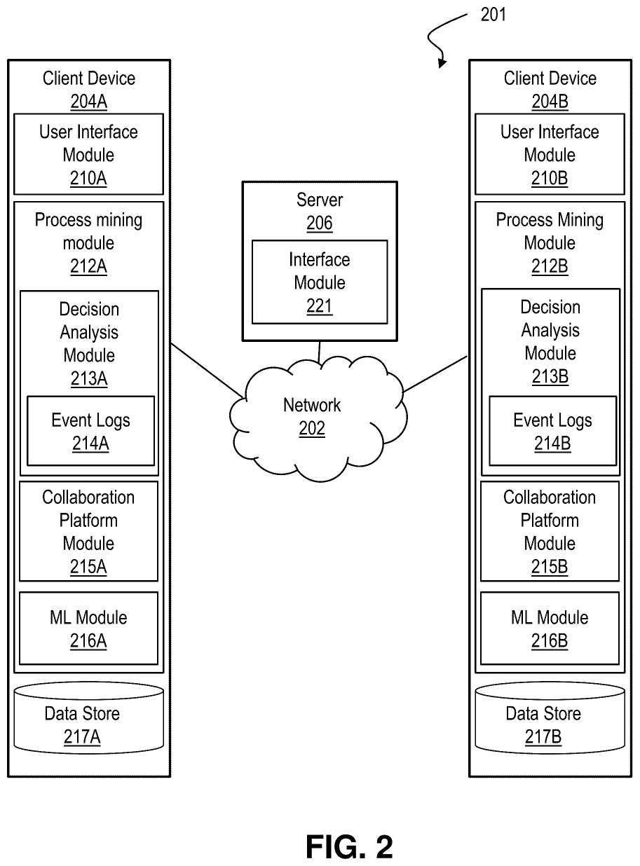

FIG. 2 shows a block diagram of an exemplary environment 201 in accordance with aspects of the invention. The environment 201 may be located within the computing environment 100 of FIG. 1. In embodiments, the environment 201 includes a network 202 (e.g., WAN 102 of FIG. 1) enabling communication between a plurality of client devices represented by client device 204A and client device 204B. In implementations, the environment 201 includes a server 206 in communication with the client devices 204A and 204B via the network 202.

The client devices 204A and 204B may each comprise an instance of the computer 101 of FIG. 1, or elements thereof. In implementations, each of the client devices 204A and 204B comprises computing nodes in a cloud computing environment. In aspects of the invention, each of the client devices 204A and 204B houses computer readable program instructions (e.g., the code in block 200 of FIG. 1) to cause a series of operational steps to be performed by processor sets (e.g., processor set 110 of FIG. 1) of the respective client devices 204A and 204B, thereby effecting a computer-implemented method discussed in more detail below. The computer readable program instructions of the client devices 204A and 204B may be stored as one or more modules in various types of computer readable storage media (e.g., persistent storage 113 of FIG. 1). These modules (e.g., of the code of block 200) may be executable by the processing circuitry 120 of FIG. 1 to perform the inventive methods as described herein.

By way of example, client device 204A is depicted as including: a user interface module 210A; a process mining module 212A associated with a decision analysis module 213A and event logs 214A; a collaboration platform module 215A; a machine learning (ML) module 216A; and a data store 217A configured to store electronic communications data. It should be understood that other client devices (e.g., client device 204B) may perform the same functions and/or include the same modules as the client device 204A. For illustrative purposes client device 204B includes modules, event logs and a data store corresponding to respective ones in client device 204A. For the sake of brevity, only the details of client device 204A are discussed below.

In aspects of the invention, the user interface module 210A is configured to enable the client device 204A to communicate with other client devices (e.g., client device 204B), and the server 206 through the network 202 (e.g., via the user interface modules 210B and 221 of the respective client device 204B and server 206).

In implementations, the process mining module 212A comprises software configured to perform one or more of: managing and creating event logs including data regarding steps of processes; generating business models and business rules based on event log data (e.g., actions or tasks performed, time of action/task, type of action/task, etc.); generating process models, such as Business Process Model and Notation (BPMN) models; and managing manual and/or automated tasks of the process models, including decision points (e.g., BPMN gateways) requiring input data regarding a defined condition or state (e.g., yes or no, true or false, etc.). Automated tasks may be performed to automatically advance a process through decision points based on condition or state information and predefined rules. For example, an automated process may proceed down a first path if a state is TRUE, and may proceed down a second path if the state is FALSE, based on saved rules.

In implementations, the process mining module 212A comprises existing data mining software enhanced with a new decision analysis module 213A configured to provide new functionality in according with embodiments of the invention. In implementations, the decision analysis module 213A is configured to determine unknown decision points (e.g., gateways) and/or unknown conditions/states associated with a decision point for a process model based on electronic communication data obtained from users. In implementations, the term event logs 214A refers to a computer-generated data log recording details regarding actions or events that occur during the lifecycle of a business process.

In embodiments, the collaboration platform module 215A is configured to enable electronic communications between users, such as email, telephonic, text messaging, and real-time audio/video communications. The collaboration platform module 215A may include or utilize tools for analyzing communications data, such as natural language processing (NLP) tools.

In aspects of the invention, the ML module 216A is configured to generate and/or train ML predictive models for use in data mining applications of the invention. In implementations, event logs from a process mining computing system are used as training data to train ML predictive models.

In embodiments, the server 206 includes computer software providing computational services to one or more paying customers. The server 206 may comprise the remote server 104 of FIG. 1, including a remote database 130 storing software tools (e.g., process mining module 212A and/or decision analysis module 213A) in accordance with embodiments of the invention. In implementations, one or more client devices (client devices 204A, 204B) download a decision analysis module (e.g., 213A) for incorporation into an existing process mining module (e.g., 212A) from the server 206. In other implementations, client devices download the process mining module 212A, including the decision analysis module 213A, from the server 206.

In embodiments, the client devices 204A and 204B and/or the server 206 of FIG. 2 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment 201 is not limited to what is shown in FIG. 2. In practice, the environment 201 may include additional devices and/or networks; fewer devices and/or networks; different devices and/or networks; or differently arranged devices and/or networks than illustrated in FIG. 2.

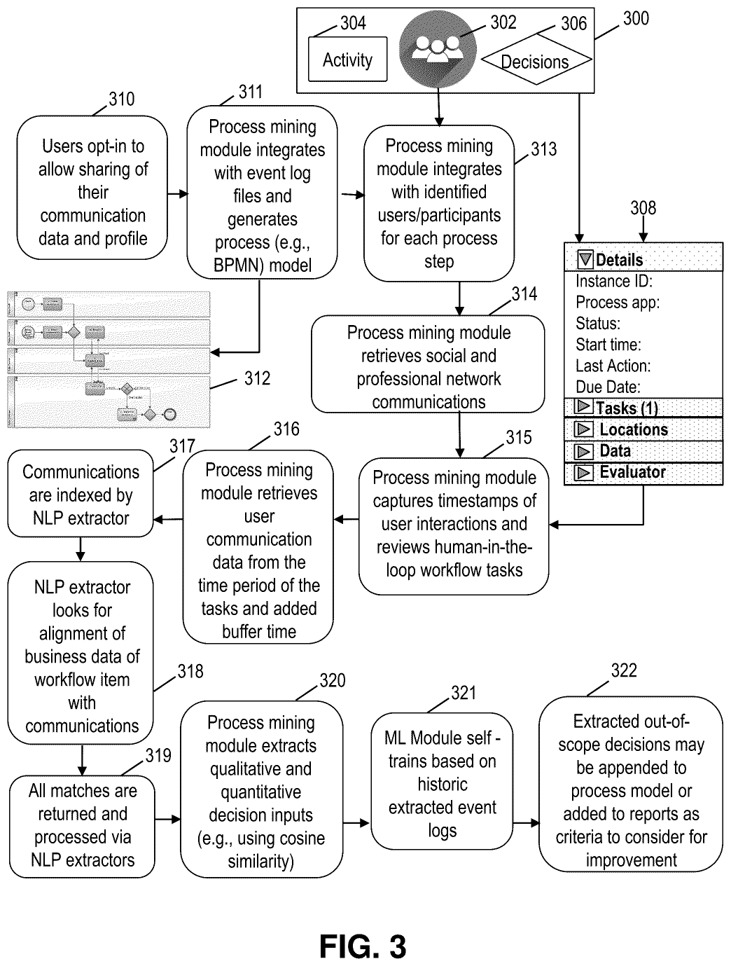

FIG. 3 depicts an overview of a decision discover process in accordance with embodiments of the invention. The steps depicted in FIG. 3 may be carried out in the environment 201 of FIG. 2, and are discussed with reference to step performed by the client device 204A.

A business process workflow represented at 300 includes steps or actions in a lifecycle of the business process workflow, including decision making points (e.g., gateways) and sub-processes in the business process. Implementation of the business process 300 involves multiple users 302 who participate in human-in-the-loop workflow tasks or activities 304 of the process, such as decision points (e.g., gateways) 306 that require a human to flag or otherwise indicate an input that determines which branch of the workflow is taken next in the process. Decision points are often depicted as diamond-shaped boxes in a business process model. As a lifecycle of a process progresses, a client device (e.g., client device 204A) generates and records event logs, represented at 308, including information about process steps, substeps and/or actions taken or completed.

With continued reference to FIG. 3, at 310 users opt-in to allow sharing of their communication data and communication profile with other users (e.g., with client devices 204A and 204B). At step 311, the process mining module 212A of the client device 204A, configured in accordance with embodiments of the invention, integrates with event log files 308 of the business process 300 and generates a business process model (e.g., a BPMN model) 312.

At step 313, the process mining module 212A integrates with identified users and participants 302 for each process step of the business process 300.

At step 314 the process mining module 212A retrieves social and professional network communications of the users and participants 302.

At step 315 the process mining module 212A captures timestamps of user interactions based on the event logs 308 and reviews human-in-the-loop workflow tasks (i.e., tasks that require a human to flag or otherwise indicate an input that determines which branch of the workflow is taken next in the process).

At step 316 the process mining module 212A dynamically adds a predetermined buffer time to the time period based on stored rules (e.g., 2 hours before and after workflow task time period), and retrieves digital user communication data from the time period of the workflow tasks (e.g., start time to completion time) and the predetermined buffer time.

At step 317 the process mining module 212A indexes the digital communications data of the users/participants using natural language processing (NLP) extractor tools.

At step 318, an NLP extractor tool of the process mining module 212A looks for an alignment (matches) between business data of the workflow item at issue and content of the digital communications data based on the indexed communications data.

At step 319, all digital communication data matches determined at step 318 are returned and processed for content via NLP extractors.

At step 320, the process mining module 212A extracts qualitative and quantitative decision inputs (out-of-scope decisions) from the content of the digital communications data using an ML model (e.g., utilizing cosine similarity).

At step 321, the ML module 216A of the client device 204A self-trains the ML model utilized by the process mining module 212A based on historic extracted event logs (e.g., event logs 308).

At step 322, the extracted qualitative and quantitative decision inputs (out-of-scope decision) may be automatically appended to the business process model 312, or added to reports as criteria to consider by a user for improvement of the business process workflow 300.

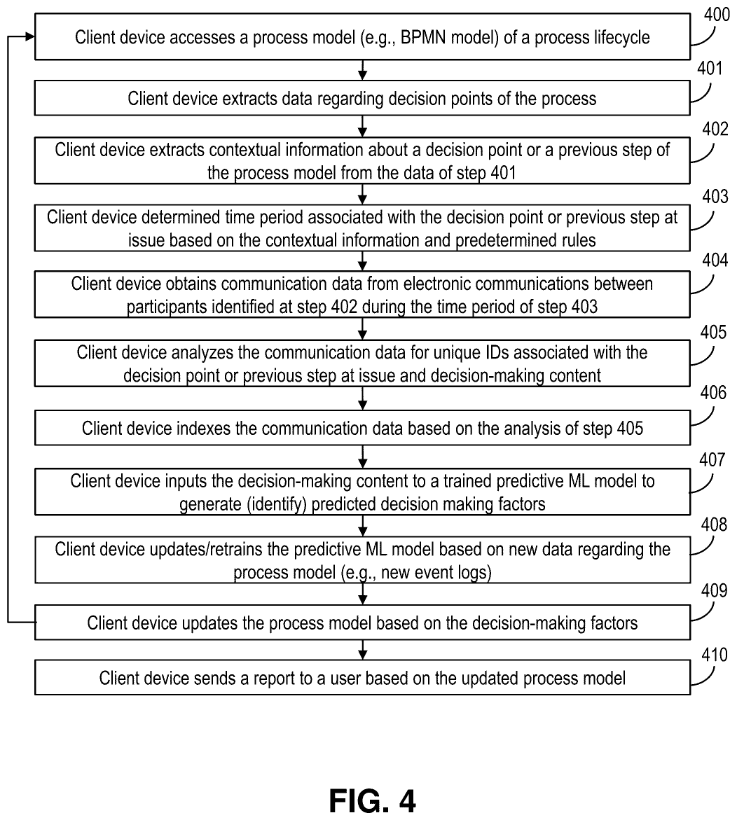

FIG. 4 shows a flowchart of an exemplary method in accordance with aspects of the present invention. Steps of the method may be carried out in the environment 201 of FIG. 2 and are described with reference to elements depicted in FIG. 2. Steps of FIG. 4 may be performed by any participating client device (e.g., client device 204B), but are discussed with reference to client device 204A of FIG. 2. It should be understood that a processor set (e.g., processor set 110) of the client device 204A may implement the steps of FIG. 4 based on computer code (e.g., Decision-Making Factor Discovery 200) of the client device 204A.

At step 400, the client device 204A accesses a business process model and associated event logs (e.g., event logs 214A) of a process lifecycle. In implementations, the business process model is in the form of a business process model and notation (BPMN) model. The term business process model as used herein refers to a data-driven representation of steps or actions in a business process lifecycle, including decision making points (e.g., gateways) and sub-processes in the business process. A business process model may include, for example: events and activities that occur within a workflow, identification of users who initiate those events and activities; decision points and the different paths workflows can take based on decision outcomes; devices involved in the process, timelines of the overall process and each step in the process, and success and failure data of the process. In implementation, the client device 204A accesses an existing business process model (e.g., in the data store 217A). In aspects of the invention, the client device 204A automatically generates the business process model via the process mining module 212A based on the event logs 214A. In implementations, decision points are associated with stored rules, which determine which of a plurality of process paths the business process model with follow from the decision point based on input data. In embodiments, the business process model represents a business process that includes automated computer-based steps or actions.

The term event logs as used herein refers to data logs recording digital information about a sequence of steps or actions performed in the business process model. Event logs may be automatically generated by a process mining computing tool (software). In accordance with embodiments of the invention the event logs 214A include one or more of: a unique identifier for a particular event (e.g., step or action) of the business process; the event (e.g., incident logging); timestamps (e.g., start and completion times); a classification; a device associated with the event; and a location (e.g., country).

In implementations, the client device 204A downloads (opts-in to) the decision analysis module 213A from the remote server 206 via the network 202. In implementations, the decision analysis module 213A embeds within an existing process mining module 212A and collaboration platform module 215A of the client device 204A. In embodiments, the process mining module 212A of the client device 204A implements step 400.

At step 401, the client device 204A extracts business process data regarding decision points (e.g., gateways) of the business process model and previous process steps from the event logs 214A or BPMN notations of the business process model and user data, including timestamp data. In embodiments, a process step is associated with a decision making point, wherein a decision input (e.g., true, false, yes, no, etc.) at the decision making point determines a next step in the business process out of multiple possible next-step options. In implementations, the client device 204A extracts data only for workflow (process) tasks that are human-in the loop workflow tasks (e.g., involve human participating or interactions as opposed to automated actions). The extracted data may include, for example, task title, task subject, fields captured, button titles, notes associated with a given task or process, user/participant data, etc. The user/participant data may be in the form of predetermined user access/permission rules regarding users who participated in the business process or step at issue. In embodiments, the previous process steps include at least one process step immediately prior to the respective decision point. In embodiments, the process mining module 212A of the client device 204A implements step 401.

At step 402, the client device 204A analyzes the data from step 401 to extract contextual information about the decision points of the business process model and associated steps (i.e., a previous step(s) performed in order to determine a decision input for the decision point). In embodiments, the extracted contextual information includes participants (users) associated with the decision points and previous steps. In implementations, the contextual information includes one or more of: a time when a task was first started; a list of users who could start the task; a list of downstream users who will retrieve/access the task; a list of managers who manage the users who could start the task and/or the users who will retrieve/access the task; relevant business data marked with importance identifiers or unique identifiers such as a customer name, ID, and other high value personalization components; and a time when the task was concluded. In embodiments, the decision analysis module 213A of the client device 204A implements step 402.

At step 403, the client device 204A determines time periods associated with the decision points and/or associated previous steps based on the contextual information from step 402 and predetermined rules. In one example, a previous step performed prior to a decision point started at time A and concluded at time B, and the rule associated with the previous step indicates a total time period from one day before the start time A, extending to one day after the conclusion time B. In implementations, the client device 204A utilizes a machine learning (ML) model trained to predict relevant time periods associated with different actions/steps in the business process model. In embodiments, the decision analysis module 213A of the client device 204A implements step 403.

At step 404, for each decision point and/or associated previous step in the business process at issue, the client device 204A obtains communication data from electronic communications between participants identified at step 402, wherein the electronic communications occurred within the determined time period associated with the decision point and/or previous step. In implementations, the client device 204A utilizes timestamp data of the communications data to determine communications between participants that occurred during the time period associated with the decision point and/or previous step. Communications data may be obtained from social networks (e.g., social media communications) or professional networks (e.g., corporate email networks). For example, the client device 204A may obtain email and text-messaging data from electronic communications between a user who started a task and a manager of the user at client device 204B for a time period of one day prior to a start time of the task until one day after a time the task was concluded (based on time data in the event logs 214A). In implementations, the client device 204A obtains the communications data from digital collaboration platforms (e.g., email software, messaging software, calendar software, video conferencing software, etc.) of one or more computing device of users/participants. In aspects of the invention, the client device 204A only obtains communication data from users who have opted-in to sharing communication data (e.g., email or text messaging data), including communication profile data. In embodiments, the decision analysis module 213A of the client device 204A implements step 404. In implementations, the decision analysis module 213A obtains the communication data from the collaboration platform module 215A, which may be an email or instant messaging platform, for example.

At step 405, the client device 204A analyzes the communication data for unique identifiers (IDs) associated with a decision point or step at issue (e.g., customer ID or a case ID), and for related decision-making content. In implementations, the client device 204A performs pre-processing of the communication data to generate text-based data from audio communication data utilizing speech-to-text computational tools. In aspects, the client device 204A leverages speech to text and fuzzy logic matching on the text and information spoken between users in the predetermined time period. In embodiments, spoken text is captured and run through a text matching algorithm to find overlap where unique IDs are found with sentiment related decision-making content. In one example, recorded data from a video conferencing meeting is processed to convert audio data to text data for NLP analysis. In embodiments, the client device 204A utilizes sentiment analysis, including NLP, text analysis computational linguistics, and/or biometrics to systematically identify, extract, quantify and analyze subjective information in the communication data. Sentiment related decision-making content may include, for example, language including “I like,” “I dislike,” “they need,” “I'm approving.” “I'm denying,” or other language indicative of a potential decision making step. In embodiments, the decision analysis module 213A of the client device 204A implements step 405.

At step 406, the client device 204A indexes the communication data based on the analysis of step 405, enabling the client device 204A to quickly access content of the communication data according to the unique IDs and sentiment related decision-making content identified at step 405. In embodiments, the decision analysis module 213A of the client device 204A implements step 406.

At step 407, the client device 204A inputs the decision-making content (e.g., sentiment related decision-making content) to a trained predictive ML model, thereby generating one or more predicted decision making factors (x-factors) as an output. In implementations, the predicted decision making factors are not factors that have been explicitly associated with the process lifecycle at issue, and may be factors that are previously unknown or unrecognized by users/participants of the process at issue. In embodiments, the decision making factors include: subjective requirements, objective requirements, and user-specific requirements for a particular decision point or process step at issue. For example, users may not recognize that decision makers have been considering a subjective requirement when making a particular determination during the lifecycle of a process. In implementations, the ML model is trained with historic data of user's associations and discussion points (including event log data) to predict decision making factors (i.e., factors likely to impact a decision point) as an output based the communication data (decision-making content) input.

In aspects of the invention, the client device 204A uses cosine similarity clustering to predict and extract predicted qualitative and/or quantitative decision inputs (decision making factors) from the communication data. Cosine similarity clustering is an ML tool utilized to cluster data based on measurements quantifying similarity between two or more vectors. In implementations, the ML model applies adjustable weights to content in the communications data based on an identity of the participants in the communication. For example, a manager may have a higher weight associated with communications content generated by the manager, indicating that the content of the manager is more likely to contain decision making factors. In embodiments, the ML module 216A of the client device 204A implements step 407.

At step 408, the client device 204A continuously or periodically updates or retrains the predictive ML model based on new data (e.g., event logs) regarding the decision point or process step at issue. In embodiments, the ML module 216A of the client device 204A implements step 408.

In embodiments, contextual and relevant decision making criteria, an importance weight, and a confidence score for the predicted qualitative and/or quantitative decision inputs are automatically generated by the client device 204A in response to detecting that a process step or decision making step in the business process has been executed. In implementations, the client device 204A monitors business process data inside a process mining application (e.g., event logs 214A of the process mining module 212A) or outside of the process mining application (e.g., electronic communications of the users). In aspects of the invention, the client device 204A monitors actual actions taken within the business process for decisions made and process actions taken and utilizes the decisions and process actions as training data to update/retrain the predictive ML model at step 408.

At step 409, the client device 204A updates the business process model (e.g., business process model 312) based on the decision making factors, thereby generating an updated business process model. In implementations, the client device 204A appends subjective requirements, objective requirements, and/or user-specific requirements for a particular decision point or process step at issue to the business process model. For example, a factor relevant to a decision making step that is discovered by the method of FIG. 4 (which is not already explicitly part of a business process lifecycle) may be incorporated into the business process model as a new factor to be determined by either an automated process or a manual process during the lifecycle of the business process. This updated business process model may then be utilized in the process of FIG. 4 starting at step 400, such that the business process model is iteratively improved over time by adding additional details to the business process model in the form of explicit decision making factors. Once decision making factors are known, one or more of the decision making factors may be automated, adding to the efficiency of the overall process mining system. In implementations, the client device 204A automates one or more decision making factors added to the business process model via the method of FIG. 4. Step 409 may be implemented upon receipt of approval or validation of the updates by a user. In embodiments, the decision analysis module 213A of the client device 204A implements step 409.

At step 410, the client device 204A sends a report to a user based on the updated business process model. In embodiments, the client device 204A sends the updated business process model to a user for approval. In aspects, the report indicates changes made to the original business process model. In embodiments, the decision analysis module 213A of the client device 204A implements step 410.

In one exemplary scenario, a triggering event within a predetermined process of a client occurs. In this example, the triggering event is a request for a build plan for a tier 2 component. An analysis of the situation indicates that a supplier cannot meet the client's demand for certain materials. A discussion among a group of workers associated with the build was conducted on a messaging platform, in which a purchasing manager mentioned the reason demand is not able to be met is because of test capacity. A decision mining model of the client includes a decision point, wherein an answer at the decision point can be true or false, and is flagged as true or false as part of the predetermined process. A decision gateway for decision mining identifies that a driver for whether or not demand can be met is a flag in a decision mining model associated with test capacity (not just any flag), in accordance with embodiments of the invention. The outcome of this process is a modification or update made to the client's test capacity resources by an invention module, which ensures that the client can meet their demand needs. In contrast to previous data mining processes that would have no context associated with why a decision making flag is true or false, embodiments of the invention provide insight into why a decision was made (i.e., why the flag is true or false). Future states of the process can be proactively modified as needed based on the context regarding why the flag is true or false, so that the client can make changes to any impacting factors (factors derived from context that impact why a decision was made).

Based on the above, it can be understood that embodiments of the invention provide a system with an invention module adapted to process user communications between two or N individuals associated with a workflow step, identify process or step indicators, and capture the NLP data surrounding that step and decisioning (decision making) of that step. In implementations, the invention module is adapted to assign importance indicators (weights) to factors taken into account in the decisioning (decision making factors) based on a sentiment of text associated with the step. In aspects, the presentation of the factors are added or inserted as a new (additional) data field in an automated process by a process mining tool, such as IBM® Process Mining. In embodiments, derived factors may be isolated as partial decision making components and ingested into an AI powered decision system, such as an automated digital sales (ADS) decision-making matrix. In implementations, the factors are taken into account at a general level or at a user level based on the clustering of user decisioning factors.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
accessing, by a processor set, a process model comprising a representation of steps in a lifecycle of a process, including a process step associated with a decision making point of the process, wherein a decision input at the decision making point determines a next step in the process from multiple next-step options;
obtaining, by the processor set and from one or more digital collaboration platforms, electronic communication data for communications between human participants in the process;
analyzing, by the processor set, the electronic communication data to identify decision making content associated with the decision making point of the process;
inputting, by the processor set, the decision making content to a trained machine learning (ML) model, thereby generating an output of a decision making factor predicted to impact the decision input at the decision making point;
automatically updating, by the processor set, the process model based on the predicted decision making factor, thereby generating an updated process model.

2. The method of claim 1, further comprising determining, by the processor set, a time period associated with the process step based on stored event logs for the process generated by a process mining computing tool, wherein the obtaining the electronic communication data comprises obtaining the electronic communication data having timestamps within the time period associated with the process step.

3. The method of claim 2, wherein the time period associated with the process step comprises a time period from a start of the process step to a conclusion of the process step, with additional buffer time added based on stored rules.

4. The method of claim 1, further comprising training, by the processor set, the ML model using historic event logs of the process.

5. The method of claim 1, wherein the electronic communication data is in a form of text-based data, and the analyzing the electronic communication data comprises identifying the decision making content using natural language processing (NLP) of the text-based data.

6. The method of claim 1, further comprising generating and sending, by the processor set, a report to a user regarding the predicted decision making factor.

7. The method of claim 1, wherein the ML model utilizes cosine similarity clustering to identify the predicted decision making factor.

8. A computer program product comprising one or more computer readable storage media having program instructions collectively stored on the one or more computer readable storage media, the program instructions executable to:
access a process model comprising a representation of steps in a lifecycle of a process, including a process step associated with a decision making point of the process, wherein a decision input at the decision making point determines a next step in the process from multiple next-step options;
obtain, from one or more digital collaboration platforms, electronic communication data for communications between human participants in the process based on timestamps of the communications;
analyze the electronic communication data to identify decision making content associated with the decision making point of the process;
input the decision making content to a trained machine learning (ML) model, thereby generating an output of a decision making factor predicted to impact the decision input at the decision making point;
automatically update the process model to explicitly include the predicted decision making factor as part of the process, thereby generating an updated process model.

9. The computer program product of claim 8, wherein the program instructions are further executable to determine a time period associated with the process step based on stored event logs for the process generated by a process mining computing tool, wherein the obtaining the electronic communication data comprises obtaining electronic communication data having the timestamps within the time period.

10. The computer program product of claim 9, wherein the time period associated with the process step comprises a time period from a start of the process step to a conclusion of the process step, with additional buffer time added based on stored rules.

11. The computer program product of claim 8, wherein the program instructions are further executable to train the ML model using historic event logs for the process.

12. The computer program product of claim 8, wherein the electronic communication data is in the form of text-based data, and the analyzing the electronic communication data comprises identifying the decision making content using natural language processing (NLP) of the text-based data.

13. The computer program product of claim 8, wherein the program instructions are further executable to generate and send a report to a user regarding the predicted decision making factor.

14. The computer program product of claim 8, wherein the ML model utilizes cosine similarity clustering to identify the predicted decision making factor.

15. A system comprising:
a processor set, one or more computer readable storage media, and program instructions collectively stored on the one or more computer readable storage media, the program instructions executable to:
access a process model comprising a representation of steps in a lifecycle of a process, including a process step associated with a decision making point of the process, wherein a decision input at the decision making point determines a next step in the process from multiple next-step options;
obtain, from one or more digital collaboration platforms, electronic communication data for communications between human participants in the process;
analyze the electronic communication data to identify decision making content associated with the decision making point of the process using natural language processing (NLP);
input the decision making content to a trained machine learning (ML) model, thereby generating an output of a decision making factor predicted to impact the decision input at the decision making point; and
generate and send a report to a user regarding the predicted decision making factor.

16. The system of claim 15, wherein the program instructions are further executable to determine a time period associated with the process step based on stored event logs for the process generated by a process mining computing tool, wherein the time period associated with the process step comprises a time period from a start of the process step to a conclusion of the process step, with additional buffer time added based on stored rules, and wherein the obtaining the electronic communication data comprises obtaining electronic communication data having timestamps within the time period.

17. The system of claim 15, wherein the program instructions are further executable to automatically update the process model to include the predicted decision making factor, thereby generating an updated process model.

18. The system of claim 17, wherein the program instructions are further executable to repeat the accessing, obtaining, analyzing, inputting, and updating steps to iteratively, automatically, update the updated process model over time.

19. The system of claim 15, wherein the program instructions are further executable to train the ML model using historic event logs for the process.

20. The system of claim 15, wherein the ML model utilizes cosine similarity clustering to identify the predicted decision making factor.
